(19) United States
(12) Patent Application Publication
(10) Pub. No.: US 2005/0272544 A1
(43) Pub. Date: Dec. 8, 2005

(54) Transmission case cover for all terrain vehicles

(76) Inventor: Chao-Chang Ho, Kaohsiung City (TW)

Correspondence Address: LEONG C LEI, PMB # 1008, 1867 YGNACIO VALLEY ROAD, WALNUT CREEK, CA, 94598, US

(21) Appl. No.: 10/862,341

(22) Filed: Jun. 8, 2004

(51) Int. Cl. F16H 57/02; F16D 13/18; F16D 1/00

(52) U.S. Cl. 474/144

(57) ABSTRACT

A transmission case cover for all terrain vehicles with a holder provided to the transmission case cover of a continuously variable transmission mechanism, an opening disposed in the space encompassed by the holder facing the crankshaft, the space being covered by a mobile cover containing also an manual starter for effective increasing the common functions of the transmission cover to reduce its production cost and promote its universality without compromising the efficacy of the continuously variable transmission.

### BACKGROUND OF THE INVENTION

(a) Technical Field of the Invention

The present invention is related to a transmission case cover for all terrain vehicles, and more particularly, to one that provides additional functions without compromising the existing functions of the transmission case.

(b) Description of the Prior Art

Referring to FIG. 1 of the accompanying drawings, a continuously variable transmission mechanism 2 is accommodated in a transmission case 11, and the power generated by an engine 12 is transmitted through a crankshaft 13 in a crankshaft case 16 for the continuously variable transmission mechanism 2 to drive. The continuously variable transmission mechanism 2 includes a pulley disk 21 disposed on the crankshaft 13, a driving disk 22 provided on the crankshaft 13 at where on one side of the pulley disk 21, a slanting board 23 provided on the crankshaft 13 at where on the other side of the pulley disk 21, a ball 24 provided and restricted between the pulley disk 21 and the slanting board 23, a passive shaft 25 to drive rear wheels, two passive disks 26 provided on the passive shaft 25, a clutch 27 fixed to the passive shaft 25, a transmission belt 28, and a bearing 29 provided on a cover 111 of the transmission case 11 to support the passive shaft 25. Wherein, the pulley disk 21 and the driving disk 22 define an active disk of the continuously variable transmission mechanism. One end of the transmission belt 28 is located at where between the driving disk 22 and the pulley disk 21 while the other end of the transmission belt 28 falls between two passive disks 26.

Power generated from the explosion in the combustion chamber of the engine 12 pushes a piston 14 to engage in reciprocal movement to drive the crankshaft 13 to rotate, and both of the pulley disk 21 and the driving disk 22 rotate synchronously; meanwhile, the ball 24 travels when subject to eccentric force. As a throttle opens wider, the rpm of the crankshaft 13 increases to subject the ball 24 to higher eccentric force; the ball 24 starts to travel outwardly to hold against the pulley disk 21; in turn, the pulley disk 21 moves toward the driving disk 22 to narrow down the distance between the driving disk 22 and the pulley disk 21, forcing the transmission belt 28 to expand for increasing the coverage of the revolving circumference of the transmission belt 28 and further to increase the rpm of both passive disks 26. The passive shaft 25 is then driven through the clutch 27 to drive the rear wheels (not illustrated). Consequently, the drive speed of the automobile is increased.

However, when the throttle is released, the eccentric force applied on the ball 24 is reduced, and the distance between the driving disk 22 and the pulley disk 21 gets larger in conjunction with the squeeze from the transmission belt 28 to reduce its coverage of the circumferential revolution. The drive speed of the automobile is decreased since the rpm of both passive disks 26 is slowed down and that transmitted to the rear wheels is also slowed down due to the reduced rpm of the passive shaft 25.

Generally, to maintain the normal operation of the continuously variable transmission mechanism 2, an air guide port 112 will be provided in front of the transmission case cover 111 to introduce in the fresh air from the ambient for cooling down the continuously variable transmission mechanism 2. The air guide port 112 is made integrated with the transmission case cover 111, and the air introduced from the ambient enters from an inlet 114 through a passage 113 into the transmission case 11 to cool the continuously variable transmission mechanism 2. The structure of the transmission case cover 111 of the prior art has been used in the trade for a long time. However, it only functions to screen the continuously variable transmission mechanism 2 and to introduce in the fresh air from the ambient. To a modem enterprise that seeks after higher universality and lower production cost, it is justified to develop the transmission case cover that can be effectively upgraded with its common functions to lower its cost and increase its universality without compromising the existing functions.

### SUMMARY OF THE INVENTION

The primary purpose of the present invention is to provide a transmission case cover for all terrain vehicles to reduce its cost and promote its universality without compromising the efficacy of the continuously variable transmission. To achieve the purpose, a holder is provided to the transmission case cover of a continuously variable transmission mechanism, an opening is disposed in the space encompassed by the holder facing the crankshaft, and the space covered by a mobile cover contains also an manual starter for effective increasing the common functions of the transmission cover.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing a structure of an engine of the prior art.

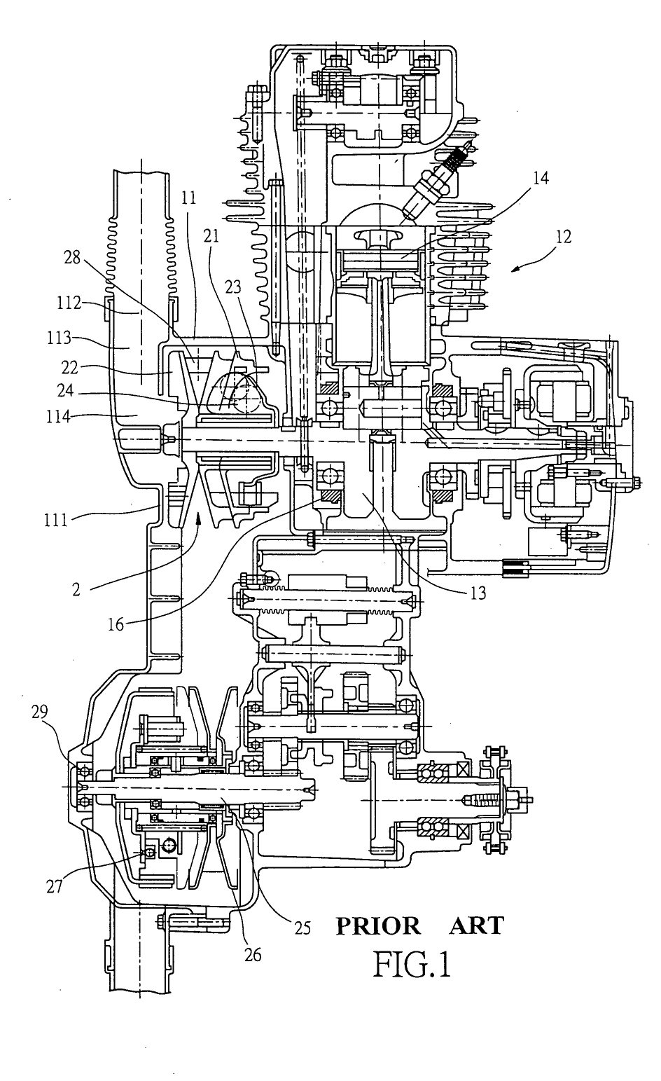

FIG. 2 is a schematic view showing a local part of an engine of a preferred embodiment of the present invention.

FIG. 3 is a perspective view of a transmission case cover of the present invention.

FIG. 4 is a schematic view showing a local part of an engine of another preferred embodiment of the present invention.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the fiction and arrangement of the elements described without departing from the scope of the invention as set forth in the appended claims.

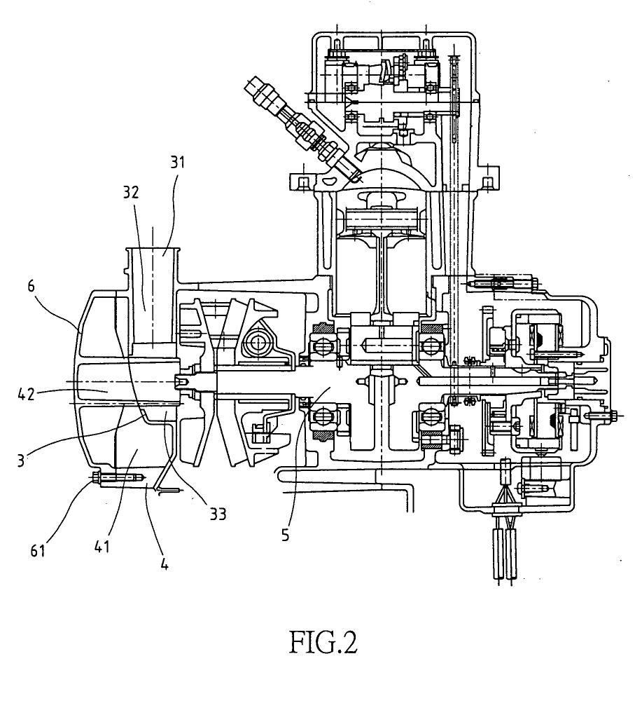

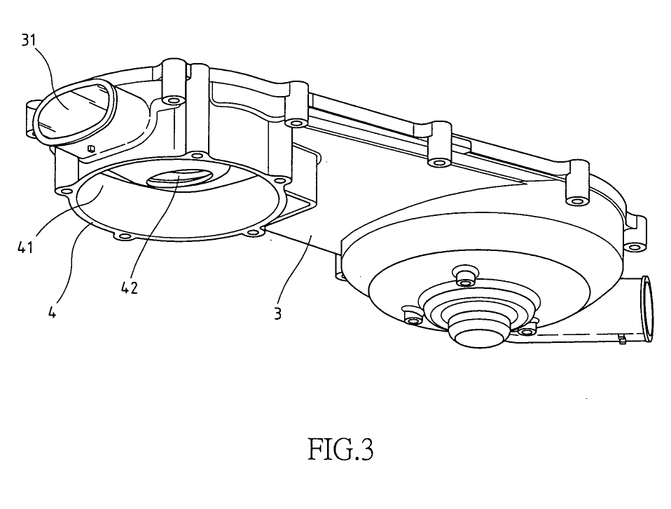

Referring to FIGS. 2 and 3, a preferred embodiment of the present invention is provided with a cover holder 4 on the outer side of a transmission case 3 at where closer to a port 31 to define a space 41 encompassed by the case holder 4. Within the space 41, an opening 42 is provided on the crankshaft 5, and the space 41 is enclosed with a cap 6, which can be mounted or removed through a screw 61 as desired without affecting the admittance of the ambient air into the transmission case through the port, a passage 32 and an inlet 32.

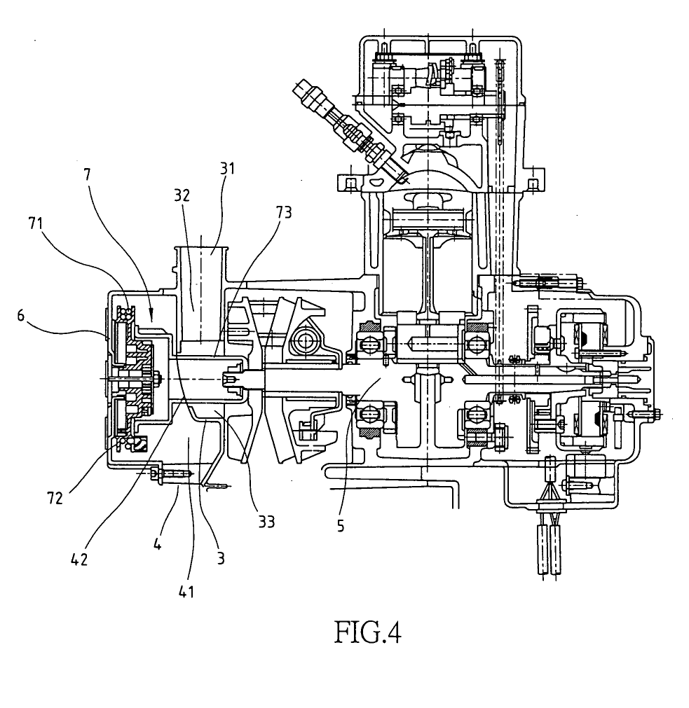

Now referring to FIG. 4 for another preferred embodiment of the present invention, the holder 4 is provided on one side of the transmission case cover 3 and the cap 6 is used to close up the space 41 encompassed by the holder 4 so to accommodate any member that provides additional function. As illustrated in FIG. 4, a pull starter 7 of the prior art is disposed inside the cap 6. With a cord 71 adapted to the starter 7 pulled to drive a drum 72, and further a starter gear 73, the crankshaft 5 rotates synchronously to start the engine. Meanwhile, the fresh air introduced from the ambient through the port 31 is not affected by the presence of the pull starter 7 provided in the cap 6. The fresh air remains passing through the port 31 into the passage 32, and the inlet to enter into the transmission case to cool the continuously variable transmission mechanism. Without affecting the existing function of the transmission case and the continuously variable transmission mechanism, the adaptation of the holder 4 and the opening 42 in conjunction with the enclosure by the cap 6 allows an additional space for the accommodation of a manual pull starter 7 to start the engine.

The present invention by providing the holder 4, the opening 42 and the cap 6 allows the transmission case applicable to the model of the automobile with or without the manual pull start of the engine at the same time to share the same transmission case cover 3 for cost reduction and increased universality of the transmission case cover 3.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A transmission case cover for all terrain vehicles comprising a continuously variable transmission mechanism, wherein the continuously variable transmission mechanism including an active disk driven by a crankshaft coupled to an engine of the automobile, a passive disk adapted to a passive shaft, a transmission belt mounted to the active disk and the passive disk, and the power from the engine being transmitted to the passive shaft through the transmission belt being characterized by that a hole being mounted to the outer side of the transmission case cover, a space encompassed by the holder being provided with an opening facing the crankshaft, and the space encompassed by the holder being enclosed by a mobile cap.

2. A transmission case cover as claimed in claim 1, wherein a manual pull starter to start the engine is mounted inside the cap.
